(19) United States
(12) Patent Application Publication
(10) Pub. No.: US 2005/0084620 A1
(43) Pub. Date: Apr. 21, 2005

(54) Method for applying a layer containing at least polymeric material

(76) Inventors: Gerlef Arjan Schuurman, Merelbeke (BE); Maarten Johannes Krupers, Romanel-sur-Lausanne (CH); Michael Hubertus Helena Meuwissen, Nieuwstadr (NL); Franky Flory Vercauteren, Eindhoven (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/276,106

(22) PCT Filed: May 14, 2001
(86) PCT No.: PCT/NL01/00363

(30) Foreign Application Priority Data
May 12, 2000 (NL) 1015188

(51) Int. Cl. B05D 1/12

(52) U.S. Cl. 427/554; 427/180; 427/553

(57) ABSTRACT

In a method for applying a layer containing at least polymer material to a substrate, there is applied to the substrate a film of polymer particles dispersed in a non-reactive liquid. By subjecting these at least polymer material-containing particles to an energy flow, which is locally at least substantially converted into heat, the particles will fuse with each other as a result of such a heat treatment. In particular, the heat treatment is done with the aid of a laser device operative in the UV region, or a laser device operative outside this region, though then in combination with a heat transferring agent in the film.

The present invention relates to a method for applying a layer containing at least polymer material to a substrate and to a method fork manufacturing an object by successively applying such layers onto each other.

It is known to manufacture such objects in a stereolithography process (SL). In such a process, often use is made of UV radiation cation-curable epoxy resins or radical-curable acrylate resins. Curing then takes place through irradiation from a laser of a particular wavelength. By each time applying a next resin layer onto a preceding cured layer and selectively curing each next layer, an object can be obtained. When the object has been completed, a post-treatment follows, often with organic solvents such as tripropylene glycol, monomethyl ether or 2-propanol, and post-curing in an oven. In such a method, during curing and post-curing, shrinkage in the order of magnitude of 2 to 7% occurs. The resultant faults (inaccuracies in form and dimensions) can cumulate strongly, especially when during curing already next layers are being applied. Partly as a result of such shrinkage, the form and dimensions of an object to be manufactured have a limited resolution, in particular at best in the order of 25-50 μm. In addition, resolution-limiting factors that apply are the minimum layer thickness and the homogeneity thereof, and the manner of crosslinking of the UV-crosslinkable stereolithography resins. Further, drawbacks that apply are that acrylates during curing are sensitive to oxygen, while epoxy resins are hygroscopic. Moreover, the resins to be used are relatively expensive.

In addition, there are other so-called rapid prototyping techniques known for manufacturing objects layer by layer, such as, for instance “laminated object manufacturing (LOM)”, “selective laser sintering (SLS)”. These techniques also have all kinds of inherent disadvantages. The technique mentioned first works with a fixed layer thickness and is suitable especially for relatively large, massive objects. Hollow forms are difficult to realize. When the latter technique is used, it is often rather cumbersome to provide sharp forms in the object, which means a reduced resolution, while further the process proceeds in a less well-defined manner; in particular, a temperature control cannot be realized with sufficient accuracy.

The object of the invention is to avoid the disadvantages of the known techniques as far as possible and to provide an entirely new method for applying a layer, in particular a relatively thin layer, comprising at least polymer material, which method is suitable in particular for forming relatively small objects.

According to the invention, to that end, the method such as it is indicated in the preamble is characterized in that a respective layer is obtained by applying to the substrate a film of at least polymer material-containing particles dispersed in a non-reactive liquid and by subjecting these particles to an energy flow which is converted in situ at least substantially into heat, during which heat treatment the particles fuse with each other. The liquid does not serve as solvent here, but has the function of transport medium to enable the polymer material-containing particles to be applied uniformly to the substrate. During the heat treatment, in principle no chemical reaction takes place, but only a direct, or indirect, thermal process, whereby evaporation of the liquid or a direct fusion of the dispersed particles can occur.

The heat treatment, whereby the polymer material-containing particles fuse, can be done with the aid of an AFM (“Atomic Force. Microscope”) “thermal analyzer” after the liquid in the film has evaporated therefrom. Depending on the volatility of the liquid and the desired process rate, a forced evaporation can take place with the aid of drying air.

The heat treatment can also be properly realized with the aid of a laser device. In a first application, the energy generated by the laser device can be employed to bond together the polymer material-containing particles in a thermal manner (fusion). In a general sense, it holds that when the energy treatment takes place utilizing a dispersion already dried without local heat treatment, this is designated as DLHT (dry layer heat treatment). When a dispersion is involved which is dried forcibly during the heat treatment process, that is, the liquid is evaporated directly under the influence of the energy employed, this is called WLHT (wet layer heat treatment).

The result of the two methods depends on many factors, such as the layer thickness applied, the solids content in the layer applied, the composition of the transport medium, the particle size, the desired process rate, etc.

In a preferred embodiment, for ease of handling, the film is formed by polymer material-containing particles dispersed in water. The size of the dispersed particles is between about 5 and 30,000 nm, and preferably between 100 and 1000 nm. In case of an emulsion polymerization, the particles will typically be in the order of 30-1000 nm; in case of a suspension polymerization, they will typically be greater than about 1000 nm. Above 30,000 nm, instead of the method according to the invention, selective laser sintering (SLS) is used.

According to the invention, both polymer particles of one single composition (homopolymer particles or copolymer particles) and of a different composition can be present. In the latter case, it is also possible that the individual polymer particles are composed of different polymers. Thus, the polymer particles can be built up from a core and a shell of different composition, for instance a core of an electrically conducting polymer and a shell of an electrically insulating polymer, or a core and a shell of different elastic properties. In that case, depending on the heat treatment, either the shells alone, or both the shells and the cores can fuse with each other. When also the cores fuse with each other, they can form particular patterns. Through selective heat treatment, it is possible in this way, for instance, to incorporate electrical conductors into an otherwise electrically insulating plastic. In addition to a makeup of polymer particles from a core and a shell of polymer material of different properties, it is also possible to take particles whose core consists of a non-polymer (for instance an organic (non-polymer), inorganic or metallic) phase which is enveloped with a polymeric phase. In addition to the core-shell particle structure, other types of hybrid materials (composites) are useful, for instance particles having a raspberry, acorn or onion structure. Naturally, all kinds of combinations of the above-mentioned polymer material-containing particles are possible. Accordingly, the particles can differ both in composition and in size.

The film to be provided on the substrate can contain, in addition to the transport medium, and the polymers dispersed therein, one or more further non-reactive components, such as, for instance, colors, pigments, flow property improving or evaporation influencing substances. It is also possible that the film contains one or more reactive components, such as, for instance, crosslinking agents to be activated in a post-treatment. Further, under circumstances to be mentioned hereinafter, a heat transferring agent, such as carbon black, may be dispersed in the film. It is also possible that ceramic particles have been added to the film, which ceramic particles are bonded to each other through the heat treatment and the fusion of the polymer material-containing particles, and, for instance, a composite pattern can be formed from which the polymeric material can be subsequently removed by firing.

To prevent coagulation in the film, the solids content in the film will be less than 70 vol. % and preferably less than 60 vol. %. A minimum solids content is not defined, since a minimum layer thickness should always be achieved.

For carrying out the heat treatment, a laser device operative in the UV region can be used. The wavelength at which the laser device is operative is then in particular between 190 and 400 nm, and is preferably between 240 and 310 nm. Below 400 nm, the polymers useful for the method described here can directly absorb the energy supplied by the laser. Moreover, such a laser device enables more accurate work: a good focusing on a relevant point on the film is rendered possible. The wavelength is selected to be greater than 190 nm, because below that value it is no longer possible to work properly in air atmosphere; a vacuum or a gas atmosphere not reactive to the laser radiation is then highly desirable. Further, the polymers can be damaged to a considerable extent by the high photon energy. Further, above 190 nm; it is still, possible to work with standard optics. Thus, working with, for instance, an F2 157 nm excimer laser device is more difficult and more expensive. In view of the above, it is therefore preferred to work with a laser in the UV region. Thus, for instance, an Argon-ion, Nd:YAG (3rd, 4th or 5th harmonic) or excimer laser device can be used.

In addition, it is also possible to use a laser device in the visible or infrared region, for instance an Nd:YAG laser device operative in the infrared region, in particular at a wavelength of about 1064 nm. Because in that case the heat supplied by the laser cannot be absorbed by the polymers useful for the method described here, it will then be necessary to add to the film a heat transferring agent, such as carbon black, as already mentioned above. For a laser device that is operative in the far infrared, such as a CO₂ laser device, however, an addition of carbon black is not necessary, because there the laser energy can be absorbed directly by the polymers. Further, other energy sources, such as, for instance, a UV lamp, can be used for drying the dispersion.

The laser device can transmit both a pulsed activation signal and a continuous activation signal. For the practice of the method, use can then be made of a scanning technique, a masking technique or another imaging technique. It is also possible, for instance, to split a laser beam into two the same way and having them meet at a point of the substrate, very locally a fusion can be effected.

When by the laser a laser beam is emitted with a normally used Gaussian intensity distribution over the beam width, the edges of the spot of the film layer to be activated will often be slightly thicker than the central portion of the spot. To prevent this, the intensity of the beam energy over the cross section will be adapted to the operation. This can be realized internally in the laser device or with the aid of other means, such as an external optical system.

The method as described so far is directed to the application of a single layer, that is, the application of a coating. However, the invention also relates to a method for manufacturing an object, specifically by building it up layer by layer each of the layers to be successively applied onto each other being obtained by the practice of the above-described method.

The invention relates not only to a method but also to an apparatus for applying a layer containing at least polymer material to a substrate, or for manufacturing an object by building it up layer by layer. To that end, the apparatus is provided with a laser device with optical components and with a processing space with a substrate on which a polymer layer, or several polymer layers to be successively applied onto each other, can be formed by the practice of the method described hereinabove. This laser device can further be provided with means for setting the intensity profile over the beam cross section. Also, a mask may be arranged in the optical path, in particular in combination with image reduction, or directly above the substrate (for a one-on-one image). An automatic setting of the transmissivity of the mask is then possible; compared with the scanning with the laser beam, the laminated build-up of an object with the aid of grating, special lenses or other aids, such as all kinds of optical systems, then proceeds faster as a result. Another possibility of selectively scanning larger surfaces is to make use of selective illumination.

The invention further relates to a coating, that is, a layer containing at least polymer material, and to an object formed by such layers, obtained by the use of the method described above.

The invention will now be further elucidated with reference to the accompanying drawing. In the drawing:

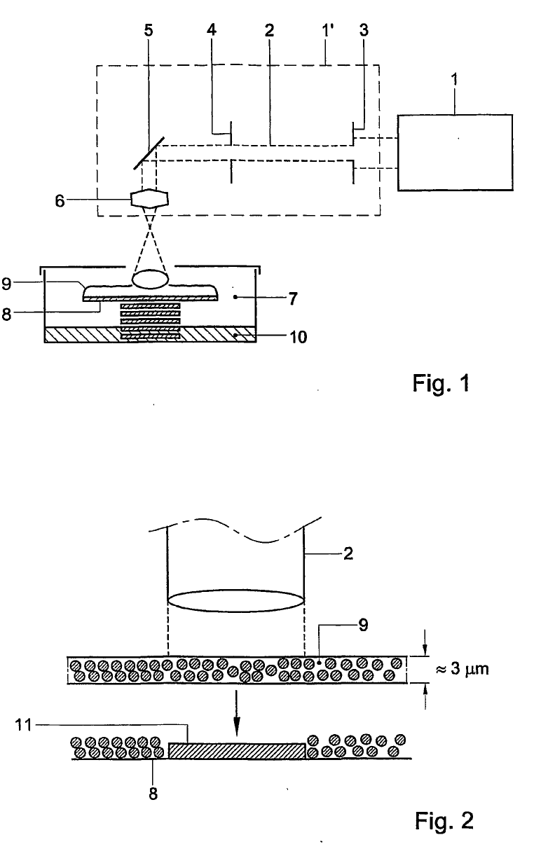

FIG. 1 shows a schematically represented set-up of an apparatus according to the invention;

FIG. 2 shows the principle of a DLHT method according to the invention;

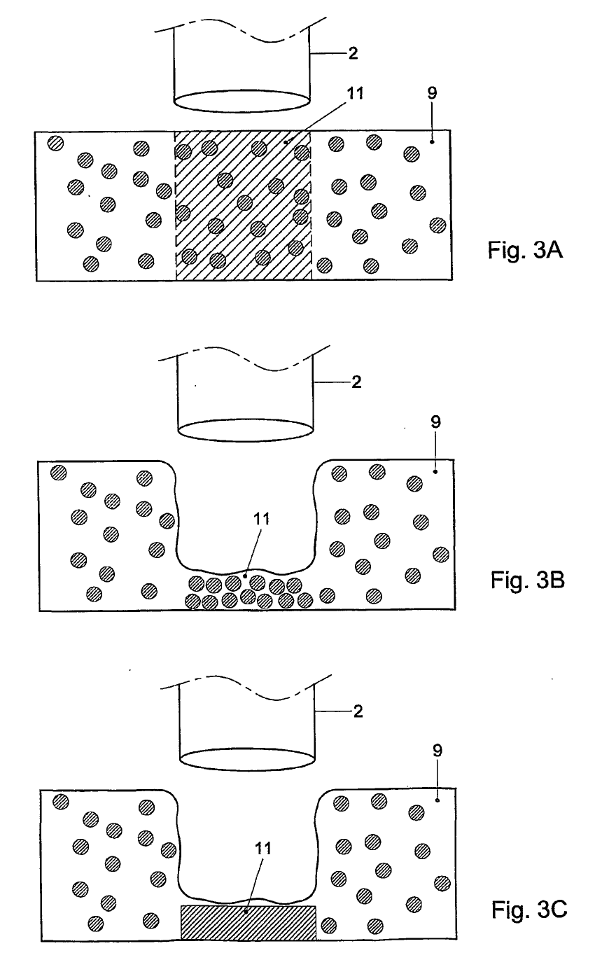

FIGS. 3A-C show the principle of a WLHT method according to the invention;

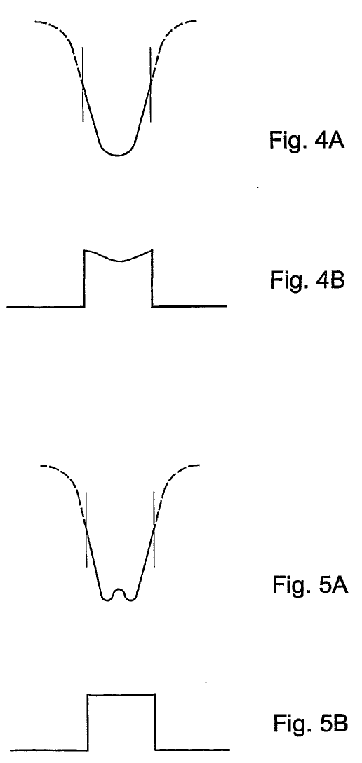

FIGS. 4A,B show a Gaussian distribution intensity profile over the laser beam cross section and a layer obtained with the aid thereof; and

FIGS. 5A,B show a modified “tophat” intensity distribution over a laser beam cross section and a more homogeneous layer obtained with the aid thereof.

The set-up of an apparatus according to the invention as schematically represented in FIG. 1 comprises an excimer laser device 1, by means of which a laser beam 2 is obtained, which, via an optical system 1′ with various optical components, such as, for instance, a first and a second diaphragm 3 and 4, respectively, a mirror 5 and a lens 6, is directed into a space 7. In the space 7, a substrate 8 is present to which a layer, or several layers to be applied onto each other, can be applied according to the method of the invention. On the substrate 8, with the aid of a doctor blade, a film 9 can be applied. When using the method according to the invention, this film, in the examples described with reference to FIGS. 2 and 3A-C, consists of water having polymer particles dispersed therein. When, as is indicated in FIGS. 3A-C, a WLHT method is pursued, the space 7 is filled with air of a high relative humidity. Present on the bottom in the space 7, when applying the film 9, is an amount 10 of a solvent for the saturated vapor in the space 7.

In a DLHT method, as is indicated in FIG. 2, a film 9 about 10 μm thick was applied to the substrate 8 with the aid of a doctor blade. The solids content of the film was 16%. The space 7 was filled with dry air. After the water had evaporated virtually completely from the film 9, a layer of about 2 μm was left. This layer was subjected to a heat treatment with the aid of an excimer laser. The temperature in the film at the site of the spot exceeded the MFFT (“minimum film forming temperature”), in this case 35 to 40° C., except in the transition area formed as a result of heat diffusion, while the temperature outside the spot remained below this MFFT. At the spot 11 irradiated by the laser beam, the polymer particles were fused with each other, and after about 1000 60 ns laser pulses a transparent layer of about 2 μm was formed. The pulse frequency was found to be of little influence on the fusion process. The pulse intensity was such that the above-mentioned MFFT-defined temperatures inside and outside the spot were maintained. The unfused polymer particles around the spot 11 were subsequently rinsed away.

In a WLHT method, as is indicated in FIG. 3, a same film of about 10 μm was applied to the substrate 8. Now, however, the film was subjected directly to a heat treatment with the aid of the excimer laser, whereby first the water at the spot 11 evaporates, while the polymer particles descended, whereafter the polymer particles fused with each other again and a transparent layer of about 2 μm was formed.

In practice, the intensity profile over the cross section of the laser beam often has a Gaussian configuration; this is indicated in FIG. 4A. The effect is that a layer is formed (see FIG. 4B) which is somewhat higher at the edges than in the middle. To compensate this effect, a beam with a modified “tophat” distribution can be used, as indicated in FIG. 5A, so that a flat layer (see FIG. 6B) can be obtained.

In the following, various facets of the invention will be elucidated in and by more concrete examples.

1. Excimer Laser

Use was made of a Lambda Physik EMG 1003i Excimer laser having a pulse energy of 200 mJ at a maximum, working at 248 nm (KrF gas mixture) with a pulse width of 60 ns. The pulse frequency used is 50 Hz. Imaging optics with a focal distance of 50 mm and an image distance of 75 mm were used, while the first pinhole for selecting a qualitatively good part of the laser beam (diameter: 1.5 mm) is at 5 cm from the laser, while the second pinhole (diameter: 1.5 mm) is at 100 cm behind the first pinhole (“filtering” of the most divergent parts), then a diaphragm and a 45°mirror to deflect the light from horizontal to vertical. The substrate is on an Oriel XYZ-positioning table (see further FIG. 1).

2. Description of Emulsion Polymerization (JZ002)

A 2 L double-walled, glass reactor equipped with a magnetic stirrer, a cooler and a thermocouple, was filled with 400 g butylmethacrylate, 0.4 g. tetrabromomethane and 1470 g demineralized water. The mixture was stirred for 45 min. (450 rpm) at room temperature, while nitrogen was passed through the mixture. Next, the reactor was heated to 70° C., whereafter a degassed, aqueous ammonium persulfate solution (13.32 g in 41.4 g demineralized water) was added. The stirring speed was lowered to 300 rpm immediately after addition of the initiator solution. About 20 min. after addition of the initiator, the stirring speed was further reduced to about 270 rpm. After about 1 hour, the stirring speed was lowered once again, to 195 rpm. 2.5 hours after starting the polymerization, the heating was switched off and the dispersion slowly cooled to room temperature. Thereupon the cooled dispersion was dialyzed in Visking dialysis tubes (31.70 mm diameter) in a bucket with flowing demineralized water. The solids content of the dispersion was 18.4%. The size of the dispersed polymer particles was determined with DCP (disk centrifuge photosedimentometry). The number-average particle size, Dn, was 826 nm. The weight-average particle size, Dw, was 827 nm. The polydispersity of the system, expressed as Dw/Dn was 1.002.

3. Description of Emulsion Polymerization (JZ057)

A substantially equal procedure was followed as described with JZ002. With JZ057, 300 g butylmethacrylate, 0.3 g dodecyl thiol (instead of tetrabromomethane), 1.95 g sodium bicarbonate and 1.03 g sodium dodecyl sulfate and 1157 g demineralized water were used. The reaction was started by addition of an ammonium persulfate solution (15.37 g in 70.29 g demineralized water). The total polymerization time was 150 min. The solids content of the dispersion was 16.1%. The size of the dispersed polymer particles was determined with DCP (disk centrifuge photosedimentometry). The number-average particle size, Dn, was 162 nm. The weight-average particle size, Dw, was 164 nm. The polydispersity of the system, expressed as Dw/Dn, was 1.008.

A part of the dispersion was evaporated under vacuum with the aid of a rotation evaporator. The solids percentage of the concentrated dispersion was 40.7%.

4. Applying Dispersion Layer

With a pipette a few drops were applied onto a microscope glass (76×0.26 mm) and then spread out in the longitudinal direction of the glass plate with a 12 μm wire doctor blade.

5. A Thicker Layer was Applied by a Kind of Flow Coating Process. A glass plate was held at an angle of about 40° and on top of the glass plate dispersion was squirted with a pipette.

6. WLHT

According to the “Wet Layer Heat Treatment” method, an applied dispersion layer (JZ002) was laid onto the sample substrate (see Example 1: “description set-up”). The applied dispersion layer was treated with a laser with the following characteristics: 50 Hz, 60 ns pulse width, 50 mm focal distance from the imaging lens, 75 mm image distance, first pinhole (diameter: 1.5 mm) at 5 cm from the laser, second pinhole (diameter: 1.5 mm) at 100 cm behind the first pinhole, then a diaphragm and a 45°mirror to deflect the light from horizontal to vertical. 50, 100, 250 and 2000 laser pulses were directed to different locations on the dispersion layer. During the laser treatments, a crater formed in the wet dispersion layer which was not flooded after the treatment with surrounding liquid. Thereafter the wet layer was dried in the air. The locations treated could be well distinguished from the locations dried in the air. The treated locations were completely transparent, while the surrounding layer was white.

7. First Variation on Example 6

Repetition of the example described under 6 “WLHT” with a focal distance of 50 mm gave spot formation only at 2000 laser pulses. At fewer laser pulses, the surrounding liquid flowed over the treated spots again. These locations were then not visible anymore after treatment.

8. Second Variation on Example 6

Repetition of the example described under 6 “WLHT”, wherein with a frequency of 50 Hz 2000 laser pulses were applied to a dispersion layer on a substrate moving at a speed of 0.1 mm/s for 50 s. After treatment, the dispersion was dried in the air; the result of this experiment was a transparent line in a white, dried dispersion.

9. Third Variation on Example 6

Repetition of the example described under 6 “WLHT”, using dispersion JZ057 (16%). 50, 100, 200, 500 and 1000 laser pulses were steered onto the wet dispersion layer. The dispersion was dried in the air. The locations with 50 and 100 pulses were not visible after laser treatment. At the other locations, transparent spots could be clearly observed.

10. Variation on Example 9

Repetition of the example described under 9 “WLHT”, using dispersion JZ057 (41%).

11. DLHT

According to the “Dry Layer Heat Treatment” method, a dispersion (JZ002) was provided on a microscope glass and subsequently dried in the air. The dried film was white, which indicates that no film formation has taken place yet. The microscope glass with the ‘dried’ dispersion layer was laid on the sample substrate (see Example 1: “description set-up”) and treated with a laser with the following characteristics: 50 Hz, 60 ns pulse width, 50 mm imaging lens, 75 mm focal distance, first pinhole (diameter: 1.5 mm) at 5 cm from the laser, second pinhole (diameter: 1.5 mm) at 100 cm behind the first pinhole, then a diaphragm and a 45°mirror to deflect the light from horizontal to vertical. 50, 100, 250 and 2000 laser pulses were controlled onto different locations on the dispersion layer. The treated spots could be well distinguished with the aid of a microscope. The treated locations were completely transparent, while the surrounding layer was white.

1. A method for applying a layer containing at least polymer material to a substrate, wherein the layer is obtained by applying, to the substrate, a film including at least polymer material-containing particles dispersed in a non-reactive liquid, and subjecting the particles to an energy flow which is locally substantially converted into heat, during which the particles fuse with each other.

2. A method according to claim 1, wherein the energy flow is provided with the aid of an Atomic Force Microscope thermal analyzer after evaporating the liquid in the film.

3. A method according to claim 1 wherein the energy flow is provided with the aid of a laser device.

4. A method according to claim 3 wherein the heat generated by the laser device is utilized first to remove the liquid from the film and then to fuse the polymer material-containing particles with each other.

5. A method according to claim 3 wherein, after the liquid has at least substantially disappeared from the film, the polymer material-containing particles fuse with each other with the aid of the laser device.

6. A method according to claim 1, wherein the film is formed by polymer material-containing particles dispersed in water.

7. A method according to claim 1, wherein the size of the dispersed particles is between about 5 and 30,000 nm.

8. A method according to claim 1, wherein polymer material-containing particles of different composition and/or size are present.

9. A method according to claim 1, wherein polymer material-containing particles have a multicomponent structure.

10. A method according to claim 1, wherein the film contains one or more further non-reactive components, from the group including: colors, pigments, and flowing property improving agents.

11. A method according to claim 1, wherein the film contains one or more reactive components, comprising crosslinking agents to be activated in a post-treatment.

12. A method according to claim 1, wherein a heat transferring agent is dispersed in the film.

13. A method according to claim 1, characterized in that the solids content in the wet film is less than 70 vol. %.

14. A method according to claim 3 wherein the laser device is operative in the UV region is used.

15. A method according to claim 14, wherein the wavelength at which the laser device is operative is between 190 and 360 nm.

16. A method according to claim 14 wherein the laser devise is an excimer laser device.

17. A method according to claim 14 wherein the laser devise is an Nd:YAG laser device.

18. A method according to claim 14 wherein the laser devise is a solid state diode pumped laser.

19. A method according to claim 3 wherein an Nd:YAG laser device is used which is operative in the infrared region, and carbon black has been added to the film as heat transferring agent.

20. A method according to claim 14, wherein the laser device transmits a pulsed activation signal.

21. A method according to claim 14, wherein the laser device transmits a continuous activation signal.

23. A method according to claim 14, wherein the laser device, viewed over the width of the beam, has a “tophat” distribution intensity profile.

24. A method for manufacturing an object by building it up layer-by layer, wherein each of the layers to be successively applied onto each other is obtained by the use of the method according to claim 1.

25. An apparatus for forming one or more layers containing at least polymer material to a substrate, wherein the apparatus is provided with a laser device and with a processing space having a substrate on which a layer, containing at least a polymer material, can be formed by the method defined in claim 1.

26. An apparatus according to claim 25, wherein the laser device is provided with means for setting the intensity profile over the beam cross section.

27. An apparatus according to claim 25 wherein a mask is arranged in the optical path.

28. A coating obtained by the use of the method according to claim 1.

30. A method according to claim 1, characterized in that the size of the dispersed particles is between about 100 and 1,000 nm.

31. A method according to claim 1, characterized in that the solids content in the wet film is less than 60 vol. %.

32. A method according to claim 12 wherein the heat transferring agent is carbon black.

33. An apparatus according to claim 25 wherein a mask is arranged directly above the substrate.
